(19) United States
(12) Patent Application Publication
(10) Pub. No.: US 2002/0033046 A1
(43) Pub. Date: Mar. 21, 2002

(54) Sensor with a three-dimensional interconnection circuit

(76) Inventors: Jose Beitia, Saint Prix (FR); Olivier Daligny, Sartrouville (FR)

Correspondence Address: LARSON & TAYLOR, PLC, 1199 NORTH FAIRFAX STREET, SUITE 900, ALEXANDRIA, VA, 22314, US

(21) Appl. No.: 09/954,202

(22) Filed: Sep. 18, 2001

(30) Foreign Application Priority Data
Sep. 19, 2000 (FR) 00 11919

(51) Int. Cl. G01P 9/00; G01C 19/00

(52) U.S. Cl. 73/504.12; 73/504.05

(57) ABSTRACT

A sensor having an element responsive to a physical quantity to be measured and carrying conducting elements and having electronics for processing useful signals received from the conducting elements or sent to the conducting elements, which electronics is carried by a base; an interconnection circuit (17) secured to the base (8) of the responsive element has a shape adapted to that of the responsive element which surrounds it so that the conducting elements are brought essentially as close as possible, but without contact, to conducting tracks (18) of the interconnection circuit and locally parallel to the conducting elements of the responsive element; flexible conducting wires (19) are disposed, slackly, between the conducting elements of the responsive element (18) and respective first ends of the printed tracks (18); conducting connections are established between opposite second ends of the tracks (18) and respective sealed insulated feedthroughs (11) of the base (8) or conducting tracks of this base.

### FIELD OF THE INVENTION

The present invention generally relates to sensors provided with electrical bonding means which are intended to join one or more electrodes or more generally the conducting elements delivering the useful signal to an outside electrical interconnection circuit supplying, on the basis of the signal, a quantity homogeneous to the sought-after physical information. The sensors can be of any type, in particular inertial (gyroscopic, accelerometric), pressure or temperature sensors etc., for which one seeks for example an angle of rotation, an angular velocity, a temperature, a pressure, etc.

### DESCRIPTION OF THE PRIOR ART

The invention finds an application in particular whenever the means of bonding link one or more electrodes or electrical contact pads placed on a vibrating element to one or more fixed elements.

It finds an especially important, but not exclusive, application in the field of gyroscopic sensors with vibrating resonator, numerous embodiments of which exist, whose interconnection circuit allows the construction of a gyroscope or of a gyrometer.

By way of example of existing technology of bonding means in vibrating gyroscopes, reference may be made to the document FR-A-2 692 349. This document describes a sensor having a mechanical resonator comprising at least four identical parallel beams secured to a common mount furnished with a foot embedded in a support base, each beam carrying, on its outward-turned faces, piezoelectric elements for excitation and for detection of the vibration of the beam. Means of electrical bonding by conducting wires join each piezoelectric element to an outside electrical interconnection circuit through a sealed insulated feedthrough of the base.

A schematic representation of the sensor, in a partially-sectioned side view, is given in FIG. 1A. The gyrometric sensor comprises a mechanical resonator 2 including at least four vibrating beams, only two of which 3a and 3d are visible in FIG. 1A, which are secured to a common socap mount 4, in the general shape of a plate from the corners of which the four beams rise.

The beams are mutually parallel, identical (and in particular have the same length and the same cross section, rectangular and in particular square) and have the same natural frequency.

The mount 4 is furnished with a central foot 5 which extends, from the mount, away from the beams and parallel to them.

The assembly of the beams, the mount and the foot is monobloc and can be machined in a block of metal with a low thermoelastic coefficient, such as that called “Elinvar”. In general, use is made of a metal with low internal damping, such as for example certain stainless steels, certain aluminium alloys or certain copper alloys (bronze, brass, etc.).

The setting into vibration and the detection of the vibrations engendered by the Coriolis forces are achieved with the aid of piezoelectric elements 6, 7, in the form of wafers fixed (for example by cementing) to the beams. These elements are disposed only on the external faces of the beams, the opposing faces of these beams being, in the embodiment illustrated, too close together to receive such elements.

The foot 5 of the mechanical resonator 2 is embedded in a support base 8, and a package or cap 9, fixed in a sealed manner to the base, surrounds the resonator 2. The resonator is thus enclosed in a sealed, tight chamber, which can be evacuated so as to increase the mechanical quality factor of the resonator.

Electrical bonds link the piezoelectric elements for setting into vibration 6 and for detection 7 and electronic means of excitation and of processing of the signals detected which are situated outside the chamber. For this purpose, an enamelled electrical wire 10 which extends, slackly, as far as a conductor 11 is connected to each piezoelectric element 6, 7. The conductor passes through the base 8 and is electrically insulated therefrom at 12. In the case illustrated the insulation is ensured by a sealed electrical feedthrough, of the glass bead type. The outside terminal part of the conductor 11 passes through a plate or printed circuit board 13, fixed under the base 8, and is soldered to a printed circuit pad 16. The printed circuits 16 of the plate 13 culminate at a connector 14, from which joining wires 15 leave heading for external electronic means (not shown).

In another embodiment (FIG. 1B), the resonator 2 is in the form of a vibrating hollow cylinder also carrying piezoelectric elements 6, 7 for excitation and for detection of vibration. Means of electrical bonding by conducting wires 10 join each piezoelectric element to an outside electrical interconnection circuit (not represented)

Such Devices Have Drawbacks.

Firstly, the wiring of the resonator 2, that is to say the fitting of the slack wires 10, is very tricky. Specifically, since each of these wires is bonded to a conducting element fixed on the responsive part or very close to the responsive part of the sensor, the disturbances introduced by the wires must be reduced to the maximum, and preferably must be negligible. Therefore, use is frequently made of conducting wires of small dimension, for example of copper wire 0.05 mm (50 microns) in diameter. These wires conveying the useful signal are preferably enamelled to obtain electrical insulation between the various conducting parts of the sensor. Their effective diameter is then increased by that of the enamel layer, this leading to more considerable diameters, of the order of 0.1 mm for a wire whose copper has a diameter of around 0.05 mm. Manipulation of conducting wires such as these is difficult. These wires must be cut to the appropriate length. The conducting parts to be linked are generally several millimetres apart, thereby defining wire lengths likewise of several millimetres. Their end must subsequently be stripped so that the conducting part of the wire is set into contact with another conducting element and fixed by brazing or cementing with the aid of conducting cement. Given the very small dimensions of the wires and the small dimensions of the electrodes to which they are linked (FIG. 1A), this task of manipulating wires, cutting to length, stripping and assemblage onto the conducting elements of the responsive part of the sensor is performed under binoculars and represents a very lengthy and tricky manual task.

Moreover, to obtain the level of performance required by the application for which the sensor is intended, the disturbances introduced by the wires and their assemblage must be reduced. The wires chosen are slender but cannot be infinitely slender. Hence, these wires have a certain rigidity and an overall mechanical behaviour which, on the one hand under the effect of temperature variations and on the other hand under the effect of mechanical loadings external or internal to the sensor, may degrade the level of performance which would be obtained naturally by the responsive part of the sensor.

By way of example, in the field of vibrating gyroscopes according to FIG. 1A, the vibrating beams constituting the responsive element of the sensor necessarily entrain in their motion each conducting wire linking the piezoelectric ceramics 6, 7 fixed on the vibrating beams to the stationary, sealed feedthroughs of the support base.

A first drawback is the damping of the vibration by the presence of the wires, movable at one of their ends and fixed at the other. This is a major drawback since the vibration of the beams constitutes the inertial memory of the sensor and any damping of the vibration destroys this memory. Moreover, this damping varies according to the temperature conditions of the device on account of the variations in the physical characteristics of the wires with temperature. To reduce the risk of rupture, and as illustrated in FIG. 1A, each wire 10 is secured at several points to the surface of the beam up to the location of the latter closest to the corresponding feedthrough conductor 11: thus, the slack wire portion is reduced to the minimum and, additionally, the point of fixing of the wire 10 situated as low down as possible on the beam is very near the lower face of the mount 4 which is a zone with minimum vibration (theoretically zero) The risk of the wires being set into vibration and the risk of a rupture are thus reduced. On the other hand, this arrangement requires several points of fixing of the wire 10 (soldering or cementing), thereby lengthening the wiring time.

Moreover, this adding of cement points degrades the performance since the cement points likewise possess a non negligible mass and behave, when the beams are vibrating, like elastic members with damping.

A second drawback is the difficulty, in such a wiring configuration, in preserving the strict symmetry of the vibrating structure in terms of stiffness and mass. Specifically, the wires, and also the elements of cement making it possible to hold the wires on the beams, modify the natural isotropy of stiffness and of mass of the structure and introduce imbalances which degrade the mechanical isolation of the structure at its resonant frequency as well as its isotropy of frequency.

As a result, the presence of the wires and of the cement points on the vibrating beams contributes to disturbing their vibrational operation and gives rise to a considerable loss of performance of the device (halving of the quality factor).

The above example can be generalized to other types of sensor for which the wiring limits the obtaining of high performance and the reducing of cost.

### SUMMARY OF THE INVENTION

The invention aims in particular to reduce the wiring time, to lower the cost of manufacture and/or to improve the performance of the sensors of any type by reducing the disturbing influence of the said wiring.

Accordingly, the invention proposes in particular a sensor having an element responsive to a physical quantity to be measured and carrying conducting elements and having electronics for processing useful signals received from the conducting elements or sent to the conducting elements, which electronics is carried by a base,

characterized in that the sensor comprises a fixed circuit with a support made of insulating material, secured to the base and surrounding the responsive element of the sensor without being in contact with the latter, the said interconnection circuit having a shape adapted to that of the responsive element so that the conducting elements and conducting tracks placed on the surface of the interconnection circuit and locally parallel to the conducting elements of the responsive element are brought essentially as close together as possible, but without contact,

in that flexible electrically conducting wires are disposed, slackly, between at least the conducting elements of the responsive element and respective first ends of the conducting tracks of the interconnection circuit, and

in that electrically conducting connections are established between opposite second ends of the conducting tracks on the interconnection circuit and respective sealed insulated feedthroughs of the base or conducting tracks of this base.

It is seen that a rigid support is added, making it possible to effect in an optimal manner, from a cost and performance point of view, the electrical bond between, on the one hand, the conducting elements or electrodes disposed on the responsive element (resonator in particular) of the sensor and, on the other hand, the electronics for processing the useful signal.

The extra member constitutes a three-dimensional interconnection circuit; in what follows, it will be called the interconnection circuit for short.

Advantageously, the interconnection circuit comprises a rigid piece drilled with holes or windows for the passage of the conducting wires joining the conducting elements of the responsive part to the ends of the tracks.

In a beneficial embodiment, the interconnection circuit comprises:

a sleeve-shaped part surrounding the responsive element of the sensor making it possible for the conducting elements of the responsive part of the sensor to be brought as close as possible, without contact, to the conducting tracks, and

a foot-shaped part surrounding the said sleeve-shaped part and extending transversely to the latter, so as to be able to cooperate with the base,

the printed conducting tracks extending both over the mutually perpendicular faces of the sleeve-shaped part and of the foot-shaped part.

The interconnection circuit can be constructed in the form of an independent piece added onto the base. More simply from the manufacturing and assembly point of view, its support may be made as a single unit with the base, and it is then possible to contrive matters such that the said foot-shaped part is integral with the base.

In an advantageous embodiment, the second ends of the printed electrical tracks are situated plumb with respective sealed insulated feedthroughs of the base and the electrically conducting connections consist of the respective conductors of the feedthroughs.

The electrical tracks are preferably of the printed type and may advantageously be made by screen printing with a conducting ink, or else be formed by etching, in particular by laser, a metallized or metallic layer covering the support of the interconnection circuit.

In one particular embodiment, the responsive element is a mechanical resonator comprising at least four identical parallel beams secured to a common mount furnished with a foot embedded in a support base and, each beam carries, on its outward-turned faces, piezoelectric elements for excitation and for detection of the vibration of the beam, constituting the conducting elements; these elements are joined electrically to so-called primary electrodes placed on the surface of a support piece of the interconnection circuit, belonging to the conducting tracks and locally parallel to the conducting elements of the responsive element.

### BRIEF DESCRIPTION OF THE DRAWINGS

The invention will be better understood on reading the description which follows of certain embodiments given solely by way of non limiting examples. This description refers to the appended drawings in which:

FIGS. 1A and 1B, already mentioned, show gyrometric sensors of known type;

FIG. 2 is a sectional schematic view of a gyroscope with mechanical resonator similar to that of FIG. 1B, with vibrating cylinder, arranged in accordance with the invention;

FIG. 3 is a simplified perspective view, cap removed, of a variant of the gyroscope of FIG. 2;

FIGS. 4A and 4B are perspective views of another embodiment of an electrical interconnection circuit usable in a gyroscope in accordance with the invention;

FIG. 5 is a sectional schematic view of another arrangement of a device with mechanical resonator equipped with an interconnection circuit; and

FIGS. 6 to 10 show examples of electrical bonding between two conducting pads by wiring of the so-called “bonding” type frequently used in the electronic components industry.

### DETAILED DESCRIPTION OF THE INVENTION

Before describing complete constructions, an indication will be given as to what is constituted by the “bonding” type wiring which is ideally suited to low-cost mass production of the kind desirable to implement the invention.

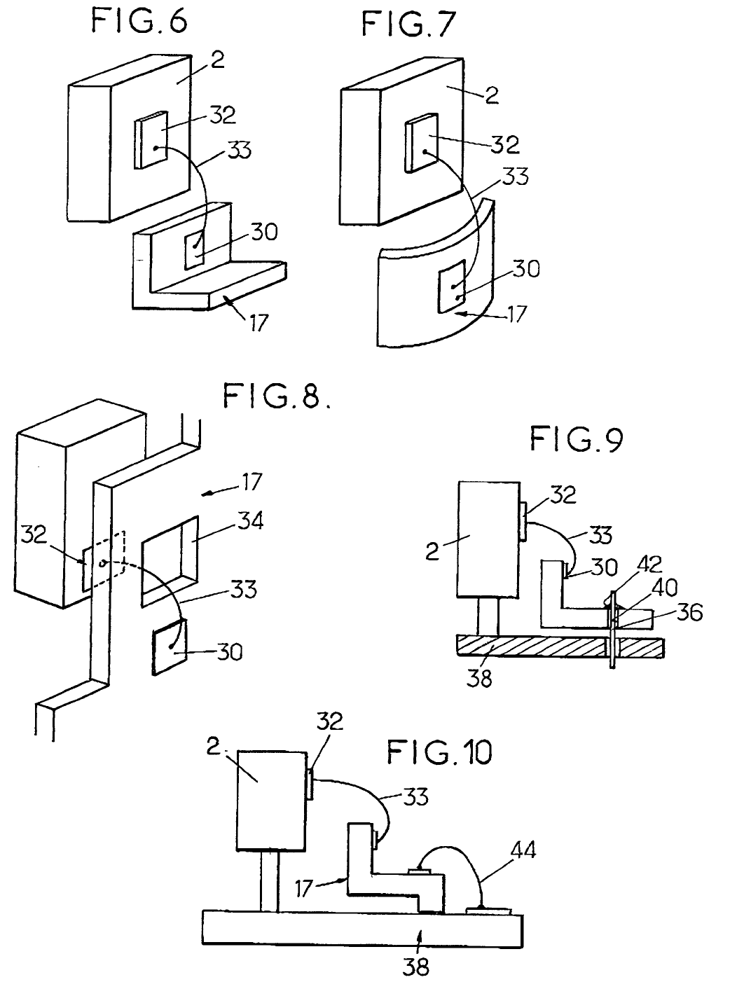

In its application to a sensor of the kind to which the invention relates, this type of wiring comprises metallized pads 30, which can constitute electrodes, situated in planes parallel (FIG. 6) or locally parallel (FIG. 7) to electrodes or conducting elements 32 disposed on the responsive element 2.

Since the wires 33 commonly employed on wiring machines involving soldering onto parallel so-called “bonding” pads may have diameters of up to as much as 25 microns, the area of the parallel conducting pads 30 on the interconnection circuit is not necessarily considerable. In practice, it will extend over a square zone whose sides have a dimension equivalent to a few wire diameters, preferably around 5 diameters, i.e., for a 25-micron wire, a side of 0.125 mm. The distance from the metallized pads of the interconnection circuit to the electrodes disposed on the responsive element governs the length of the wires employed. This length will advantageously be limited to around 15 mm for two reasons:

a long wire is more fragile than a short wire, during the wiring operation and over the life of the sensor, when it experiences the operational environment;

a wire is characterized by a mass, a stiffness and a damping; the longer this wire the more it will disturb the structure to which it is bonded; for these same reasons, use will also be made of wires of small diameter, in practice of the order of 25 microns in diameter, or even, if possible, less than 25 microns in diameter.

FIGS. 6 and 7 show wiring configurations for which the bonding zone situated on the electrode of the responsive element is offset with respect to the bonding zone situated on the interconnection circuit. However, such an interconnection circuit may equally well comprise holes or windows 34 (FIG. 8) placed facing the electrodes and through which the “bonding” wire 33 can be routed. This novel wiring possibility is accessible with the aid of so-called “deep access” “bonding” wiring heads. The holes, for the tools currently available, must be of the order of 5 mm wide, and the depth separating the two electrodes to be linked may be up to a few millimetres. These dimensions are limited by the state of the art of current machines and will certainly evolve in the direction of reducing the size of the holes and increasing the depth separating the electrodes or pads.

In the same way as in order to effect the connections to the electrodes disposed on the responsive element, other electrodes of the interconnection circuit 17 make it possible to effect the connections to the electronics for processing the useful signal. These other electrodes will be referred to as “secondary electrodes” whereas the electrodes described above and linked to the electrodes disposed on the responsive element will be referred to as “primary electrodes”. Several possibilities may be envisaged for bonding the secondary electrodes to the external electronics in so far as the severe constraints on the size, the diameter and more generally the shape of the bonding wires employed on the primary electrodes disappear. Various possibilities will now be described.

A first possibility (FIG. 9) uses metal pins 36 to effect sealed conducting feedthroughs through a support piece 38, which is for example metallic or made of plastic. These pins may be oriented in any manner with respect to the plane defined by the primary electrodes. The interconnection circuit then has holes 40 which can be metallized, into which the pins are threaded. These holes emerge on the secondary electrodes 42. The bond between the secondary electrodes 42 and the pins is then effected by brazing or cementing with conducting cement.

A second possibility (FIG. 10) uses a support piece 38 having conducting tracks, as may be the case when using electronic boards of a printed interconnection circuit. In this case, the bonds of the secondary electrodes may again be effected with the aid of “bonding” wires 44, provided that these conducting tracks are contained in planes parallel to the plane defined by the secondary electrode, on a scale of a few wire diameters, i.e. typically on a scale of 0.1 mm for wires 25 microns in diameter.

A few sensor construction examples will now be described.

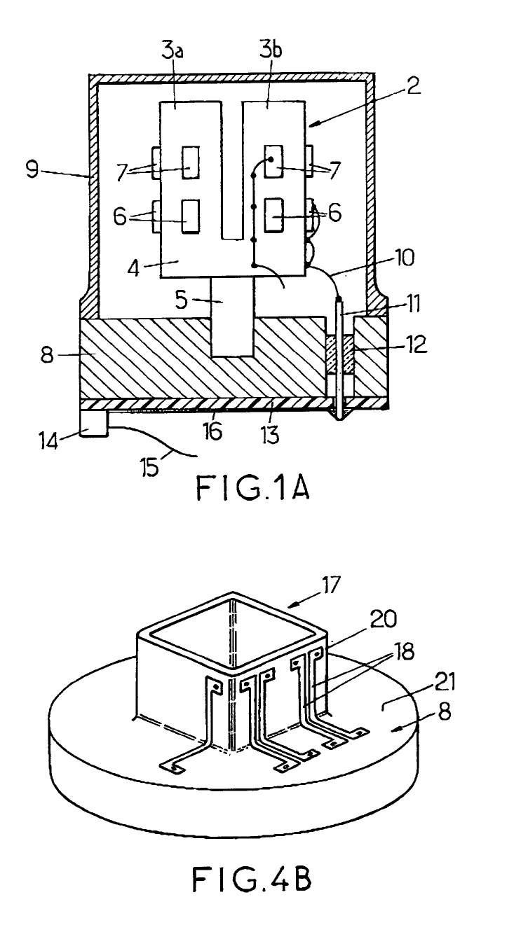

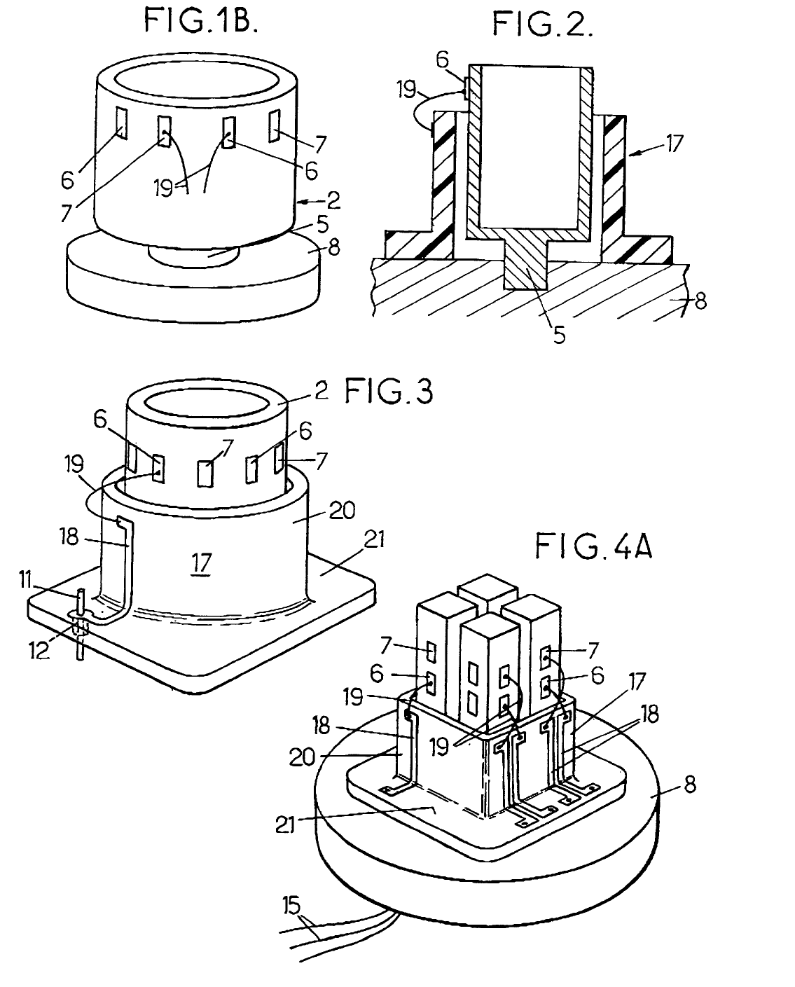

So as not to complicate the drawings, only one or a few electrical bonds between the piezoelectric elements 6, 7 and the outside connection wires 15 have been represented in FIGS. 2 to 5. In these figures, the same numerical references denote the members similar to the corresponding ones of FIGS. 1A and 1B. The bonds required for the functioning of the gyroscope are constructed in accordance with the indications which follow.

FIGS. 2 and 3 show a gyroscope arrangement similar to that with a mechanical resonator of FIG. 1B, wherein the resonator has a foot 5 projecting away from the vibrating cylinder. The interconnection circuit 17 of FIGS. 2 and 3 may be used with responsive members different from those illustrated.

The electrical interconnection circuit 17 comprises a support made of a substantially rigid insulating material which is secured to the base (FIG. 8) or made in one piece with it (FIG. 3) and which surrounds the mechanical resonator 2. The rigid support of the interconnection circuit 17 remains at every point separated from the resonator 2 so as not to prevent or impede the vibrational operation of the latter. The height of the interconnection circuit is less than or equal to the height of the piezoelectric elements 6 and 7 disposed as low down as possible.

The rigid support of the interconnection circuit 17 carries, on its external surface, electrically conducting printed tracks 18 which can be constructed in any manner appropriate to this function (for example metallized or metallic layer, made of nickel for example, covering the rigid support and in which furrows are made in particular by etching, for example by means of a laser, so as to isolate conducting zones; metallized tracks which are screen-printed, in particular with a conducting ink, as is illustrated in the figures).

These printed conducting tracks 18 extend as far as the upper edge, or at least as far as the immediate vicinity of the upper edge of the support piece, so that electrically conducting flexible wires 19 may be disposed, slackly, between the piezoelectric elements 6, 7 and the first ends (or first electrodes) of the printed tracks 18, these flexible wires 19 then being very short.

Moreover, at the opposite ends or second electrodes of the tracks 18 printed on the interconnection circuit 17, electrically conducting connections (not represented in FIG. 2) are established with the respective conductors 11 of the sealed insulated feedthroughs 12 of the base 18, of the kind shown in FIG. 1A.

In the embodiment of the interconnection circuit 17 illustrated in FIG. 3, this interconnection circuit 17 takes the form of a monobloc support piece, added on and fixed to the base 8, and whose external surface is three-dimensional. This interconnection circuit comprises:

a part 20 in the shape of a well or sleeve which surrounds the mechanical resonator 1 under the aforesaid conditions; the external surface of this sleeve 20 is substantially parallel to the vibrating cylinder and, in the example illustrated, this sleeve exhibits, in cross section, a cylindrical general shape, locally plane at the level of the conducting pads supporting the bonding wires bonded to the semiconducting ceramics, possibly also being quadrangular, and in particular square, which hugs the external contour of the vibrating cylinder as closely as possible without however touching it; and

a foot-shaped part 21 surrounding the said sleeve-shaped part 20 and extending substantially transversely to the latter so as to be able to cooperate with the base 8 on which it rests and is fixed.

The printed conducting tracks 19 then extend simultaneously on the mutually perpendicular external faces of the sleeve-shaped part 20 and foot-shaped part 21, thus forming a three-dimensional printed interconnection circuit. Possibly, if necessary, certain printed tracks may be interconnected.

In FIG. 2, the support of the interconnection circuit 17 is an independent piece which is secured to the base 8 by any appropriate means (cementing, screwing, etc.). To reduce the number of component pieces, it is possible to construct the base 8 and the interconnection circuit 17 in the form of a single, monobloc piece. The interconnection circuit 17 retains the structure described above, with a foot-shaped part 21 forming a raised plateau with respect to the surrounding upper face. Or else the foot-shaped part 21 is sunk into the base 8 and its upper face then coincides with the upper face of the base 8.

However, for the purpose of simplifying the structure of the gyroscope as far as possible, and hence of reducing its manufacturing cost, matters may be contrived, as illustrated in FIG. 3, such that the conducting tracks 18 printed on the support are arranged and fashioned so as to extend until they are in line with the respective sealed feedthroughs 12 of the base 8; the foot-shaped part 21, when it exists, of the interconnection circuit 17 is also of the necessary extent to cover the said sealed insulating feedthroughs 12. Under these conditions, it is sufficient to accord the respective feedthrough conductors 11 the appropriate length so that their ends project beyond the second ends or second electrodes of the printed tracks 18; the projecting ends of the conductors 11 may thus be soldered directly to the printed tracks 18.

More generally, the bond between the primary and secondary electrodes on the circuit can be achieved in two ways, any solution by wiring of leads being excluded on account of the search for a low-cost, high-performance industrial solution.

The first way can be used when the electrodes are made by transferring a conducting ink or by local metallization on an electrically insulating support piece. In this case, the same process for transferring the electrodes can be used to bond them together.

The support may be obtained by machining or moulding, depending on the sought-after cost, in a material which combines good thermal, mechanical and electrical properties and which exhibits no rejection phenomenon with regard to the add-on metallic layer. Such a material may be chosen from the range of amorphous thermoplastics. The superior mechanical characteristics of this material make it possible in respect of certain embodiments to envisage a single piece instead of two for making the interconnection circuit and the support piece bearing the responsive element.

FIG. 4A shows an interconnection circuit embodiment usable in particular in the case of a gyrometric sensor, the contour of whose resonator is shown. The insulating support is hollow at the centre, symmetric about a vertical axis passing through its centre. Independent conducting tracks 18 link the primary electrodes, in this particular case disposed on the top of the support, to the secondary electrodes, in this case disposed on the bottom of the support. The three-dimensional nature of this interconnection circuit is achieved through the fact that the primary and secondary electrodes are disposed in orthogonal planes. Although this is not represented, the conducting tracks may be bonded to one another and follow a complex layout on the support piece.

This technique demands that the metallization and its layout on the support should be accessible so that they can be achieved. Hence, such an interconnection circuit will have tracks situated on the exterior faces of the support piece and the number of traversing tracks or those placed inside will be limited.

A second way offers an alternative. In this case, the insulating support is obtained in several steps by moulding, the conducting tracks being made during one step, and then covered with insulating material during a next step.

In the embodiment of FIG. 4B, the support is made in one piece with the base.

In all cases, the length of the bonding wires 19 between the piezoelectric elements 6, 7 and the corresponding first ends (or first electrodes) of the printed tracks 18 is appreciably reduced relative to what it was in the previous arrangement. Hence, these wires may be supported solely by the soldering of their terminations, and they need no longer be fixed at intermediate locations: a considerable number of operations is thus saved.

Additionally, by reason of their reduced length, the wires, which are no longer necessarily enamelled, can have a smaller diameter: thus, typically, this diameter may be decreased to a value of the order of 25 μm, thereby not only lowering the cost thereof, but also decreasing the mass thereof and hence the disturbing effect on the vibration of the resonator.

Finally, the arrangement in accordance with the invention allows complete automation of the fitting and soldering of the wires 19: this results in a considerable speeding up of this step, which typically may be shortened to a duration of a few minutes (instead of a duration of the order of 3 hours for the previous manual procedure).

The provisions in accordance with the invention have just been set forth and represented in conjunction with an embodiment of the mechanical resonator 2 with projecting foot 5, that is to say in which the foot 5 extends, relative to the mount 4, away from the vibrating beams.

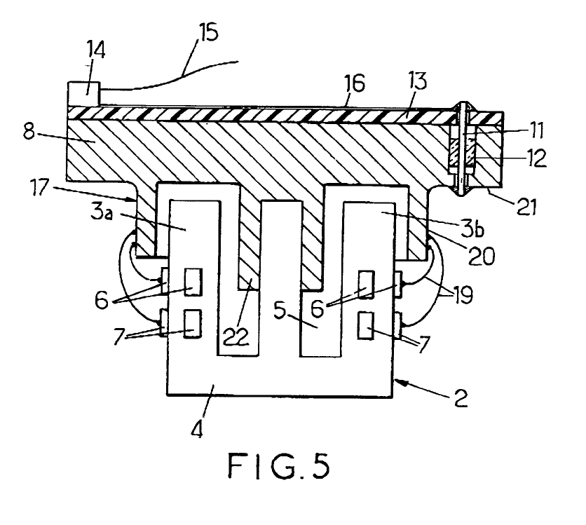

The same provisions may apply equally to a mechanical resonator with vibrating beams which are relatively separated from one another and with a foot turned, with respect to the mount 4, to the same side as the beams and in a position centred between them. Such an arrangement is represented in FIG. 5, retaining the same numerical references to denote identical members. In this case, the base 8 comprises a central protrusion 22 into which the foot 5 is embedded, so that the base surmounts all the vibrating beams 3a-3d. In the example illustrated in FIG. 5, an arrangement of the interconnection circuit 17 similar to that illustrated in FIG. 4B has been assumed, that is to say one which is integrated into the base 8, the sleeve-shaped part 20 here extending in the downward direction.

The invention is open to still numerous other applications, in particular whenever it is necessary to link a conducting element carried by a vibrating part of a member to a remotely situated site close to a fixed support, carrying for example the foot of the member.

What is claimed is:

1. A sensor having an element responsive to a physical quantity to be measured and carrying conducting elements and having electronics for processing useful signals received from the conducting elements or sent to the conducting elements, which electronics is carried by a base,
wherein said sensor comprises a fixed interconnection circuit with a support made of insulating material, secured to the base of the responsive element and surrounding the responsive element of the sensor without being in contact with the latter, the said interconnection circuit having a shape adapted to that of the responsive element so that the conducting elements are brought essentially as close as possible, but without contact, to conducting tracks placed on the surface of the interconnection circuit and locally parallel to the conducting elements of the responsive element,
wherein flexible electrically conducting wires are disposed, slackly, between at least the conducting elements of the responsive element and respective first ends of the printed conducting tracks of the interconnection circuit, and
wherein electrically conducting connections are established between opposite second ends of the tracks and respective sealed insulated feedthroughs of the base or conducting tracks of this base.

2. A sensor according to claim 1, wherein said interconnection circuit comprises a rigid piece drilled with holes or windows for the passage of the conducting wires joining the conducting elements of the responsive part to the ends of the tracks.

3. A sensor according to claim 1, wherein said interconnection circuit comprises:
a sleeve-shaped part surrounding the responsive element of the sensor making it possible for the conducting elements of the responsive part of the sensor to be brought as close as possible, without contact, to the conducting tracks, and
a foot-shaped part surrounding the said sleeve-shaped part and extending transversely to the latter, so as to be able to cooperate with the base, the printed conducting tracks extending both over the mutually perpendicular faces of the sleeve-shaped part and of the foot-shaped part.

4. A sensor according to claim 1, wherein said interconnection circuit is a piece added onto the base and secured to the latter.

5. A sensor according to claim 1, wherein said interconnection circuit is constructed as a single unit with the base.

6. A sensor according to claim 1, wherein said conducting tracks terminate near the responsive element via primary electrodes locally parallel to the conducting elements.

7. A sensor according to claim 1, wherein said second ends of the printed electrical tracks are situated plumb with respective sealed insulated feedthroughs of the base and in that the electrically conducting connections comprise the respective conductors of the said feedthroughs.

8. A sensor according to claim 1, wherein said electrical tracks printed on the interconnection circuit are made by screen printing with a conducting ink.

9. A sensor according to claim 1, wherein said electrical tracks printed on the interconnection circuit are made by etching, in particular by means of a laser, a metallic layer covering a rigid support of the said interconnection circuit in such a way that conducting zones are insulated in said layer.

10. A sensor according to claim 1, wherein said electrically conducting flexible wires disposed between the conducting elements of the responsive element and the first ends of the conducting tracks printed on the interconnection circuit are not enamelled and have a diameter of the order of 25 μm.

11. A gyroscopic sensor according to claim 1, wherein the responsive element is a mechanical resonator comprising at least four identical parallel beams secured to a common mount furnished with a foot embedded in a support base, each beam carrying, on its outward-turned faces, piezoelectric elements for excitation and for detection of the vibration of the beam, constituting the conducting elements.
